(19) United States
(12) Patent Application Publication
(10) Pub. No.: US 2026/0060398 A1
(43) Pub. Date: Mar. 5, 2026

(54) PROTECTIVE CASE FOR A 3D INPUT DEVICE

(71) Applicant: David K. Wetherington, GOLDEN, CO (US)

(72) Inventor: David K. Wetherington, GOLDEN, CO (US)

(21) Appl. No.: 18/826,119

(22) Filed: Sep. 5, 2024

(51) Int. Cl. A45C 13/00; A45C 11/00; G06F 3/039

(52) U.S. Cl. CPC A45C 13/002; G06F 3/039; A45C 11/003

(57) ABSTRACT

The present disclosure provides a protective case for a 3D input device, which includes a rigid top shell having a cavity to receive the 3D input device. Additionally, the protective case includes a rigid bottom shell, where the rigid bottom shell and the rigid top shell are mechanically connected via mechanical locking means to enclose the 3D input device. The protective case also includes a flexible shock-absorbing base disposed in the rigid bottom shell. Moreover, the protective case includes a flexible shock-absorbing ring disposed between the rigid top shell and the base of the 3D input device. The flexible shock-absorbing ring compresses the base of the 3D input device against the flexible shock-absorbing base in the rigid bottom shell when the protective case is closed. Furthermore, a joystick of the 3D input device is suspended and protected from contact with the rigid top shell and the rigid bottom shell.

### TECHNICAL FIELD

The present disclosure relates to the field of device handling and, in particular, relates to a protective case for a 3d input device.

### BACKGROUND

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Three-dimensional (3D) input devices have become increasingly important in various fields, including computer-aided design (CAD), 3D modeling, and graphics software. These devices, such as the SpaceMouse, offer users an intuitive way to navigate and manipulate 3D environments. Unlike traditional mice that operate in two dimensions, 3D input devices typically feature a joystick or puck that allows for movement and rotation along all three spatial axes.

Traditionally, the SpaceMouse consists of a base containing sensitive electronics and a joystick (also referred to as a puck) with six degrees of freedom (6 DoF), allowing users to pan, zoom, rotate, or any combination thereof the view of 3D models with greater ease and precision. This capability makes the SpaceMouse an essential tool for professionals in fields like engineering, architecture, and digital content creation.

However, the advanced functionality of 3D input devices comes with inherent challenges, particularly in terms of portability and protection. The joystick mechanism, which is central to the device's functionality, is highly sensitive and can be easily damaged if subjected to excessive force or impact during transportation. This vulnerability presents a significant problem for professionals who need to transport their 3D input devices between different work locations or to client sites or any other scenario.

Existing solutions for protecting 3D input devices during transportation have several limitations. Standard bags or general-purpose electronics cases do not provide adequate protection for the delicate components of these specialized devices. While some manufacturers offer dedicated carrying cases, these often fall short in addressing the specific needs of 3D input devices.

One common issue with existing cases is that they allow the device to move or shift during transport. This movement can put stress on the joystick mechanism, potentially leading to misalignment or damage. Additionally, many cases do not provide sufficient shock absorption, leaving the device vulnerable to impacts that could occur during normal handling or accidental drops.

Another challenge with current protective solutions is their inability to securely hold both the base and the joystick of the 3D input device. Cases that focus solely on protecting the base may leave the joystick exposed to potential damage. Conversely, cases that envelop the entire device might apply pressure to the joystick, which could affect its calibration or functionality over time.

For wireless versions of 3D input devices, an additional complication arises from the need to transport associated accessories, such as USB receivers or charging cables. Many existing cases do not provide dedicated storage for these small but crucial components, increasing the risk of loss or damage to these accessories.

Furthermore, the design of many current protective cases does not take into account the ergonomic considerations that are important for professionals who frequently transport their devices. Bulky or poorly designed cases can be cumbersome to carry and may not integrate well with other professional equipment.

These limitations in existing protective solutions create a significant gap in the market for 3D input device users. The lack of adequate protection can lead to increased maintenance costs, downtime due to damaged equipment, and potential loss of productivity for professionals who rely on these devices for their work.

In light of the foregoing discussion, there exists a need for an improved protective case which can address at least one of the above discussed requirements.

### SUMMARY

Before the present system and method and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present disclosure. This summary is not intended to identify essential features of the claimed subject matter nor is it intended for use in detecting or limiting the scope of the claimed subject matter.

In an example aspect, the present disclosure provides a protective case for a 3D input device. The protective case may include a rigid top shell having a cavity to receive the 3D input device. In addition, the protective case may include a rigid bottom shell, where the rigid bottom shell and the rigid top shell are mechanically connected to each other via mechanical locking means to enclose the 3D input device. The protective case may include a flexible shock-absorbing base which is disposed in the rigid bottom shell. Moreover, the protective case may include a flexible shock-absorbing ring which is disposed between the rigid top shell and a base of the 3D input device. Further, the flexible shock-absorbing ring compresses the base of the 3D input device against the flexible shock-absorbing base in the rigid bottom shell when the protective case is closed. Furthermore, a joystick of the 3D input device is suspended and protected from contact with the rigid top shell and the rigid bottom shell.

In an embodiment, the rigid top shell and the rigid bottom shell are made from 3D printed, molded, milled, or any combination thereof from a durable material. Further, the durable material includes a high-impact plastic, metal alloy, or a combination thereof.

In another embodiment, the durable material is treated with a UV-resistant coating to prevent discoloration and degradation over time.

In yet another embodiment, further includes a slot in the rigid top shell for retaining a USB Fob or other accessory of the 3D input device.

In yet another embodiment, the flexible shock-absorbing ring is made of a resilient material that withstands repeated compression and deformation. Further, the resilient material includes shock-absorbing foam, rubber, or a combination thereof.

In yet another embodiment, the rigid top shell and the rigid bottom shell have a contoured shape that matches form factor of the 3D input device, providing a snug and secure fit.

In yet another embodiment, further includes foam, air pockets, or a combination thereof as an additional interior padding and cushioning to provide shock and impact protection for the 3D input device.

In yet another embodiment, the mechanical locking means includes one or more latches, one or more clips, one or more snap-fit features, or any combination thereof to a secure and reliable closure of the rigid top shell and the rigid bottom shell of the protective case.

In yet another embodiment, the rigid bottom shell includes adjustable feet for improved stability on various surfaces.

In yet another embodiment, the flexible shock-absorbing base is made from a memory foam material that conforms to a shape of the 3D input device for customized protection.

### BRIEF DESCRIPTION OF FIGURES

Having thus described the disclosure in general terms, references will now be made to the accompanying figures, wherein:

FIG. 1 illustrates an exploded view of a protective case for a 3D input device, in accordance with various embodiments of the present disclosure;

FIG. 2 illustrates an exploded view from side of the protective case for the 3D input device, in accordance with various embodiments of the present disclosure; and FIG. 3 illustrates a cross-sectional view of the protective case for the 3D input device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

Reference will now be made in more detail to embodiments, examples of which are illustrated in the accompanying drawings, wherein like reference numerals refer to like elements throughout the specification. In this regard, the present embodiments may have different forms and should not be construed as being limited to the descriptions set forth herein. Accordingly, the embodiments are merely described below, by referring to the figures, to explain aspects of embodiments of the present description. As used herein, the term “and/or” includes any and all combinations of one or more of the associated listed items. Throughout the present disclosure, the expression “at least one of a, b and c” indicates only a, only b, only c, both a and b, both a and c, both b and c, all of a, b, and c, or variations thereof.

The subject matter of the present disclosure may include various modifications and various embodiments, and example embodiments will be illustrated in the drawings and described in more detail in the detailed description. Effects and features of the subject matter of the present disclosure, and implementation methods therefor will become clear with reference to the embodiments described herein below together with the drawings. The subject matter of the present disclosure may, however, be embodied in many different forms and should not be construed as limited to the embodiments set forth herein.

Hereinafter, embodiments of the present disclosure will be described in more detail with reference to the accompanying drawings. The same or corresponding elements will be denoted by the same reference numerals, and thus, redundant description thereof will not be repeated.

It will be understood that although the terms “first,” “second,” etc. may be used herein to describe various elements, these elements should not be limited by these terms. These terms are only used to distinguish one element from another.

An expression used in the singular may also encompasses the expression of the plural, unless it has a clearly different meaning in the context.

In the following embodiments, it is to be understood that the terms such as “including,” “includes,” “having,” “comprises,” and “comprising,” are intended to indicate the existence of the features or elements disclosed in the specification, and are not intended to preclude the possibility that one or more other features or elements may exist or may be added.

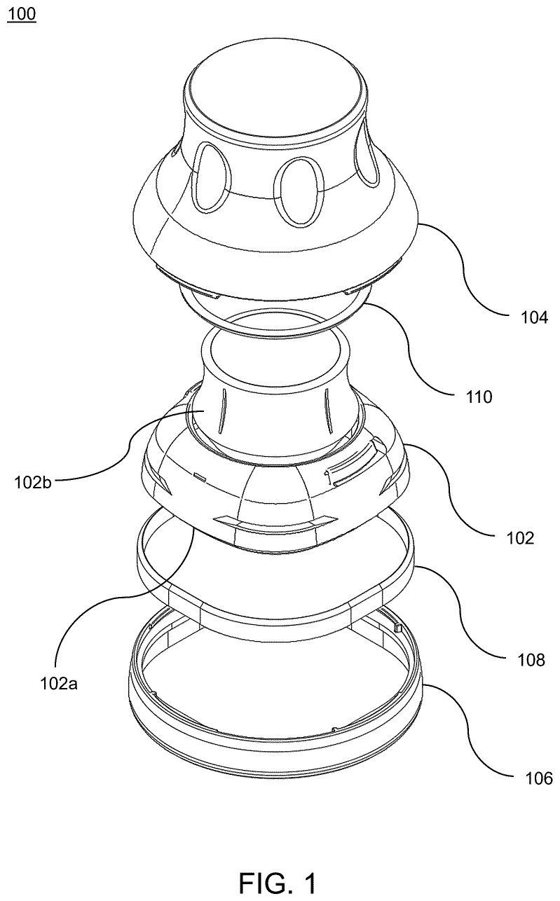

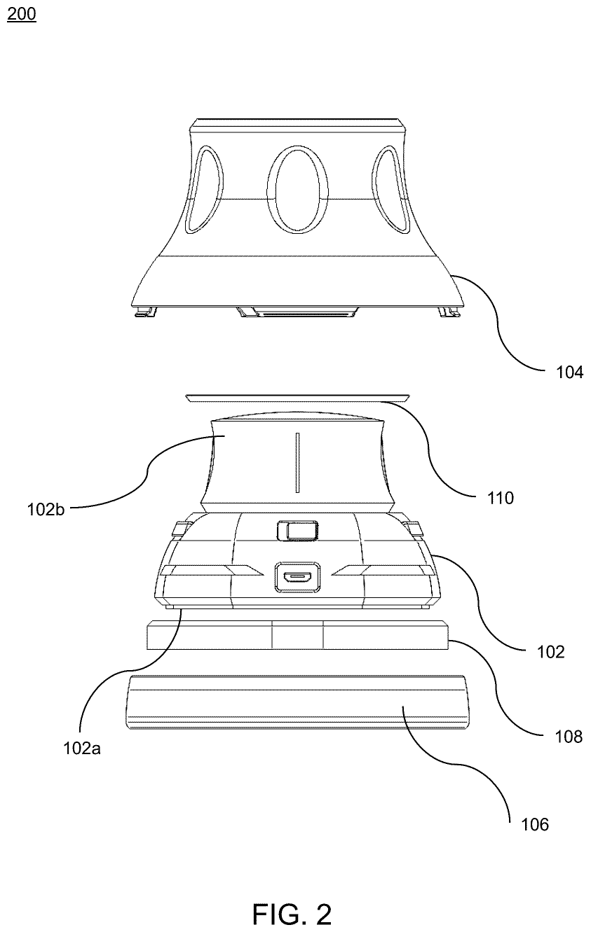

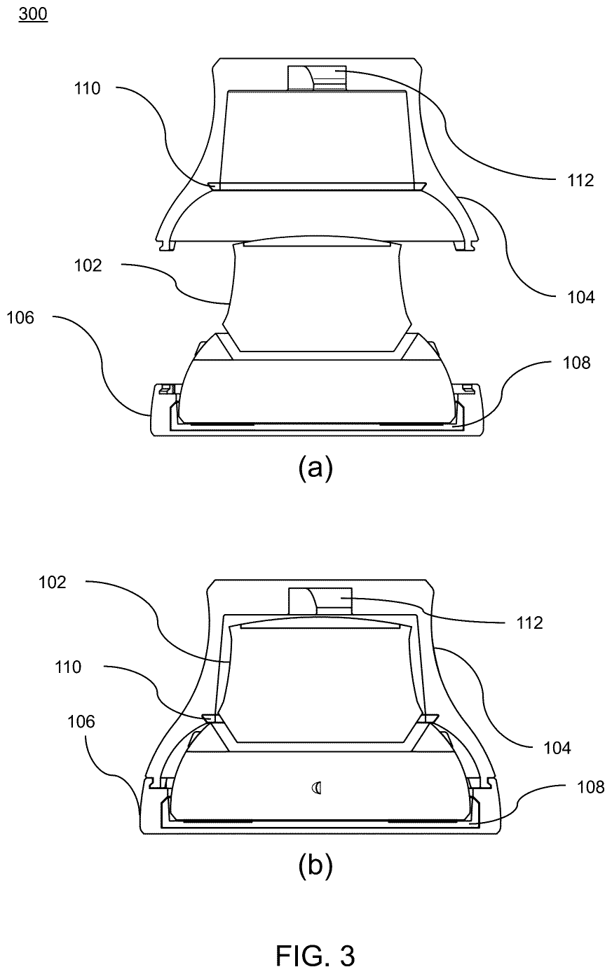

FIG. 1 illustrates an exploded view 100 of a protective case for a 3D input device, in accordance with various embodiments of the present disclosure. FIG. 2 illustrates an exploded view from side 200 of the protective case for the 3D input device, in accordance with various embodiments of the present disclosure. FIG. 3 illustrates a cross-sectional view 300 of the protective case for the 3D input device, in accordance with various embodiments of the present disclosure.

In an aspect, the protective case for the 3D input device 102 is disclosed. The protective case includes a rigid top shell 104, a rigid bottom shell 106, a flexible shock-absorbing base 108, and a flexible shock-absorbing ring 110. In an embodiment, the rigid top shell 104 having a cavity to receive the 3D input device 102. Further, the rigid bottom shell 106 and the rigid top shell 104 may be mechanically connected to each other via mechanical locking means to enclose the 3D input device 102. Furthermore, the flexible shock-absorbing base 108 may be disposed in the rigid bottom shell 106. Also, the flexible shock-absorbing ring 110 may be disposed between the rigid top shell 104 and a base 102a of the 3D input device 102.

In an embodiment, the flexible shock-absorbing ring 110 may compress the base 102a of the 3D input device 102 against the flexible shock-absorbing base 108 in the rigid bottom shell 106 when the case is closed. Further, a joystick 102b of the 3D input device 102 may be suspended and protected from contact with the rigid top shell 104 and the rigid bottom shell 106.

In some embodiments, the rigid top shell 104 may include at least one ventilation port to prevent overheating of the 3D input device 102. Further, the flexible shock-absorbing ring 110 may have a variable thickness to accommodate different models of the 3D input device 102. In one example, the mechanical locking means may include a magnetic closure system for quick and secure attachment. In some embodiments, the protective case may feature a built-in cable management system to organize and protect connection cables. In an example, the rigid bottom shell 106 may include adjustable feet for improved stability on various surfaces. In another example, the protective case may incorporate a biometric lock for enhanced security of the 3D input device 102.

In some embodiments, the rigid top shell 104 and the rigid bottom shell 106 may be made from 3D printed, molded, milled, or any combination thereof from a durable material. Further, the durable material may include at least one of a high-impact plastic, metal alloy, or a combination thereof.

In one example embodiment, the rigid top shell 104 and the rigid bottom shell 106 may be reinforced with carbon fiber for increased strength and reduced weight. In one example, the manufacturing process may utilize injection molding techniques for precise tolerances and consistent quality. In another example, the durable material may be treated with a UV-resistant coating to prevent discoloration and degradation over time. In yet another example, the rigid top shell 104 and the rigid bottom shell 106 may incorporate a multi-layer construction for enhanced durability and shock resistance. In an example implementation, the rigid top shell 104 and the rigid bottom shell 106 may be made from a self-healing polymer that can repair minor scratches and dents. In yet another example, the rigid top shell 104 and the rigid bottom shell 106 may feature an antimicrobial surface treatment to inhibit the growth of bacteria and other microorganisms.

In an embodiment, the protective case may further include a slot 112 in the rigid top shell 104 for retaining a USB Fob or other accessory of the 3D input device 102. In some example embodiments, the slot 112 may be equipped with a spring-loaded mechanism for secure retention of the USB Fob or accessory. In one example, the slot 112 may also include a dust cover to protect the USB Fob or accessory when not in use. In another example, the rigid top shell 104 may feature multiple slots to accommodate various accessories. In yet another example, the slot 112 may be designed with a universal adapter system to fit different types of accessories. In an example, the slot 112 may incorporate a quick-release mechanism for easy access to the USB Fob or accessory. In another example, the slot 112 may be equipped with an LED indicator to show the connection status of the USB Fob or accessory.

In some embodiments, the flexible shock-absorbing ring 110 may be made of a resilient material that withstand repeated compression and deformation. Further, the resilient material may include at least one of shock-absorbing foam, rubber, or a combination thereof. In some example embodiments, the flexible shock-absorbing ring 110 may incorporate a multi-density foam structure for optimized shock absorption. In an example, the flexible shock-absorbing ring 110 may feature a honeycomb design for enhanced energy dissipation. In another example, the resilient material may be infused with phase-change materials for improved temperature regulation. In yet another example, the flexible shock-absorbing ring 110 may be designed with varying thicknesses in different areas to provide targeted protection. In an example embodiment, the flexible shock-absorbing base 108 and the flexible shock-absorbing ring 110 may be made from a memory foam material that conforms to the shape of the 3D input device 102 for customized protection. In another example, the flexible shock-absorbing ring 110 may incorporate a gel-based cushioning system for enhanced comfort and protection.

In a non-limiting example, the 3D input device 102 may include at least one of wired SpaceMouse and wireless SpaceMouse.

In another implementation, the protective case may feature a built-in wireless charging system for various models of the wireless SpaceMouse. In one example, the protective case may include a dedicated compartment for storing extra batteries for wireless models. In an embodiment, the protective case may be designed to accommodate both wired and wireless SpaceMouse versions with interchangeable inserts.

In some embodiments, the rigid top shell 104 and the rigid bottom shell 106 may have a contoured shape that matches form factor of the 3D input device 102, providing a snug and secure fit. In one example, the contoured shape may be achieved through 3D scanning technology for precise replication of the 3D input device 102 form factor. In another example, the rigid top shell 104 and the rigid bottom shell 106 may incorporate flexible zones that allow slight expansion to accommodate minor variations in device dimensions. In yet another example, the contoured shape may include strategically placed reinforcement ribs for enhanced structural integrity. In yet another example, the fit may be further customized with adjustable padding inserts. In an example implementation, the rigid top shell 104 and the rigid bottom shell 106 may feature a modular design that allows for easy replacement of individual sections. In yet another example, the contoured shape may incorporate ergonomic grips for improved handling of the protective case.

In an embodiment, the protective case may further include at least one of foam, air pockets, or a combination thereof as an additional interior padding and cushioning to provide shock and impact protection for the 3D input device 102. In some embodiments, the interior padding may utilize a combination of open-cell and closed-cell foams for optimized shock absorption. Further, the air pockets may be designed as interconnected chambers that distribute impact forces evenly. In one example, the padding and cushioning may incorporate smart materials that stiffen upon impact for enhanced protection. In another example, the interior may feature a customizable padding system that allows users to adjust protection levels for different areas of the device. In yet another example, the padding may include a moisture-wicking layer to protect against condensation. In an example, the cushioning may incorporate vibration-dampening materials to reduce mechanical stress on the 3D input device 102.

In some implementations, the mechanical locking means may include at least one of one or more latches, one or more clips, one or more snap-fit features, or any combination thereof to a secure and reliable closure of the rigid top shell 104 and the rigid bottom shell 106 of the protective case. In an example, the mechanical locking means may incorporate a multi-point locking system for enhanced security. In another example, the latches or clips may be designed with an auto-locking feature that engages when the case is closed. In yet another example, the snap-fit features may utilize a progressive engagement design for a smooth and secure closure. In some example embodiments, the locking mechanism may include a visual indicator to confirm proper closure. In an example embodiment, the locking mechanism may incorporate a pressure-release system to equalize internal air pressure when opening the case. In another example, the locking mechanism may feature a tamper-evident seal for added security during transportation.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the scope of the present disclosure as defined by the following claims, and equivalents thereof.

What is claimed is:

1. A protective case for a 3D input device, the protective case comprising:
a rigid top shell having a cavity to receive the 3D input device;
a rigid bottom shell, wherein the rigid bottom shell and the rigid top shell are mechanically connected to each other via mechanical locking means to enclose the 3D input device;
a flexible shock-absorbing base is disposed in the rigid bottom shell; and
a flexible shock-absorbing ring disposed between the rigid top shell and a base of the 3D input device, wherein the flexible shock-absorbing ring compresses the base of the 3D input device against the flexible shock-absorbing base in the rigid bottom shell when the protective case is closed, wherein a joystick of the 3D input device is suspended and protected from contact with the rigid top shell and the rigid bottom shell.

2. The protective case of claim 1, wherein the rigid top shell and the rigid bottom shell are made from 3D printed, molded, milled, or any combination thereof from a durable material, wherein the durable material comprises a high-impact plastic, metal alloy, or a combination thereof.

3. The protective case of claim 2, wherein the durable material is treated with a UV-resistant coating to prevent discoloration and degradation over time.

4. The protective case of claim 1, further comprising a slot in the rigid top shell for retaining a USB Fob or other accessory of the 3D input device.

5. The protective case of claim 1, wherein the flexible shock-absorbing ring is made of a resilient material that withstands repeated compression and deformation, wherein the resilient material comprises shock-absorbing foam, rubber, or a combination thereof.

6. The protective case of claim 1, wherein the rigid top shell and the rigid bottom shell have a contoured shape that matches form factor of the 3D input device, providing a snug and secure fit.

7. The protective case of claim 1, further comprising foam, air pockets, or a combination thereof as an additional interior padding and cushioning to provide shock and impact protection for the 3D input device.

8. The protective case of claim 1, wherein the mechanical locking means comprises one or more latches, one or more clips, one or more snap-fit features, or any combination thereof to a secure and reliable closure of the rigid top shell and the rigid bottom shell of the protective case.

9. The protective case of claim 1, wherein the rigid bottom shell comprises adjustable feet for improved stability on various surfaces.

10. The protective case of claim 1, wherein the flexible shock-absorbing base is made from a memory foam material that conforms to a shape of the 3D input device for customized protection.
